(19) United States
(12) Patent Application Publication
(10) Pub. No.: US 2012/0099602 A1
(43) Pub. Date: Apr. 26, 2012

(54) END-TO-END VIRTUALIZATION

(75) Inventors: Venkatesh Nagapudi, Milpitas, CA (US); Satsheel B. Altekar, San Jose, CA (US)

(73) Assignee: BROCADE COMMUNICATIONS SYSTEMS, INC., San Jose, CA (US)

(21) Appl. No.: 13/157,942

(22) Filed: Jun. 10, 2011

Related U.S. Application Data
(60) Provisional application No. 61/406,443, filed on Oct. 25, 2010.
(60) Provisional application No. 61/466,360, filed on Mar. 22, 2011.

(51) Int. Cl. H04L 12/56

(52) U.S. Cl. 370/401

(57) ABSTRACT

One embodiment of the present invention provides a system that facilitates end-to-end virtualization. During operation, a network interface residing on an end host sets up a tunnel. The network interface then encapsulates a packet destined to a virtual machine based on a tunneling protocol. By establishing a tunnel that allows a source host to address a remote virtual machine, embodiments of the present invention facilitate end-to-end virtualization.

### RELATED APPLICATIONS

This application claims the benefit of U.S. Provisional Application No. 61/406,443, Attorney Docket Number BRCD-3068.0.1.US.PSP, entitled “End to End Virtualization with MPLS,” by inventors Venkatesh Nagapudi and Satsheel B. Altekar, filed on 25 Oct. 2010, the contents of which are herein incorporated by reference.

This application also claims the benefit of U.S. Provisional Application No. 61/446,360, Attorney Docket Number BRCD-3068.0.2.US.PSP, entitled “End to End Virtualization,” by inventors Venkatesh Nagapudi and Satsheel B. Altekar, filed on 22 Mar. 2011, the contents of which are herein incorporated by reference.

### BACKGROUND

1. Field

The present disclosure relates to network management. More specifically, the present disclosure relates to a method and system for end-to-end virtualization.

2. Related Art

As cloud computing continues to explore the unprecedented advances in computer hardware, virtualization technologies are gaining progressively more momentum. With virtualization, a physical computer can host a number of virtual machines (VMs), each operating as a stand alone computer and can provide a plethora of functions (server, storage, etc.). On the physical host computer, a management entity, often called “hypervisor,” controls and manages different virtual machines.

As part of the virtual machine architecture, the physical host also provides a virtual switch which couples to and dispatches packets among multiple VMs. This virtual switch forwards packets based on their layer-2 header information (e.g., MAC address and/or VLAN tag). In addition, a VM is identified by its virtual MAC address and optionally the associated VLAN tag. Generally, a VM is assigned a private IP address, just like a regular host on a subnet.

A VM can only be individually addressed within the same layer-2 network domain (e.g., within the same Ethernet domain). This is because when a packet traverses a layer-3 device, which typically strips away all the layer-2 information to process layer-3 headers, the identity of the VM is lost. As a result, a remote host outside the layer-2 domain cannot initiate communication with a particular VM, because there is no way to address the VM from outside the layer-2 network domain. In other words, virtualization is only available within the same layer-2 network, and is not visible (i.e., individual VMs are not visible) to an entity outside that layer-2 network. Without special mechanisms, end-to-end virtualization is not attainable across different layer-2 networks where a packet needs to be switched by a network device operating above layer-2.

End-to-end virtualization is desirable in many use cases. For example, a server can benefit from a dedicated virtual storage. However, if the server and virtual storage reside in different layer-2 networks, such end-to-end virtualization is difficult to attain.

### SUMMARY

One embodiment of the present invention provides a system that facilitates end-to-end virtualization. During operation, a network interface residing on an end host sets up a tunnel. The network interface then encapsulates a packet based on a tunneling protocol, thereby allowing virtual machine identifying information in the packet's layer-2 header to be preserved.

In a variation on this embodiment, the network interface stores mapping information between a destination entity's identifying information and a tunnel's identifying information.

In a further variation, the destination entity is a virtual machine.

In a further variation, the destination entity's identifying information comprises at least one of a layer-2 address and a virtual local area network tag.

In a further variation, the tunnel's identifying information comprises at least one of: a multiprotocol label switching (MPLS) label, an Internet Protocol (IP) address, and a generic routing encapsulation (GRE) key.

In a variation on this embodiment, the tunneling protocol is MPLS. Furthermore, the packet is encapsulated with an inner end-to-end label and an outer hop-by-hop label.

In a variation on this embodiment, the network adapter decapsulates a packet encapsulated based on the tunneling protocol.

### BRIEF DESCRIPTION OF THE FIGURES

FIG. 1A illustrates an exemplary network environment that provides storage virtualization.

FIG. 1B illustrates using tunnels to achieve end-to-end virtualization, in accordance with an embodiment of the present invention.

FIG. 2 illustrates how a tunnel can be built between the network interface cards, in accordance with an embodiment of the present invention.

FIG. 3 illustrates how a tunnel can be built between network interface cards using multiprotocol label switching, in accordance with an embodiment of the present invention.

FIG. 4A presents a diagram illustrating how a packet can be encapsulated in tunneling protocol headers as it traverses a network, in accordance with an embodiment of the present invention.

FIG. 4B illustrates an exemplary MPLS tunnel-to-VM mapping table maintained at a network interface, in accordance with one embodiment of the present invention.

FIG. 5 presents a flowchart illustrating the process of establishing tunnels to facilitate end-to-end tunneling, in accordance with an embodiment of the present invention.

FIG. 6 illustrates an exemplary Generic Route Encapsulation (GRE) packet format that facilitates end-to-end virtualization, in accordance with an embodiment of the present invention.

FIG. 7 illustrates an exemplary GRE tunnel-to-VM mapping table maintained at a network interface, in accordance with one embodiment of the present invention.

FIG. 8 illustrates an exemplary network interface that supports end-to-end virtualization, in accordance with an embodiment of the present invention.

In the figures, identical label numbers refer to similar items in different figures.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of facilitating end-to-end virtualization across multiple layer-2 network domains is solved by encapsulating packets with VM identifying information based on a tunneling protocol. As a result, the VM identifying information can be preserved when the packet traverses network devices that remove layer-2 headers. An end host can therefore directly address a remote VM.

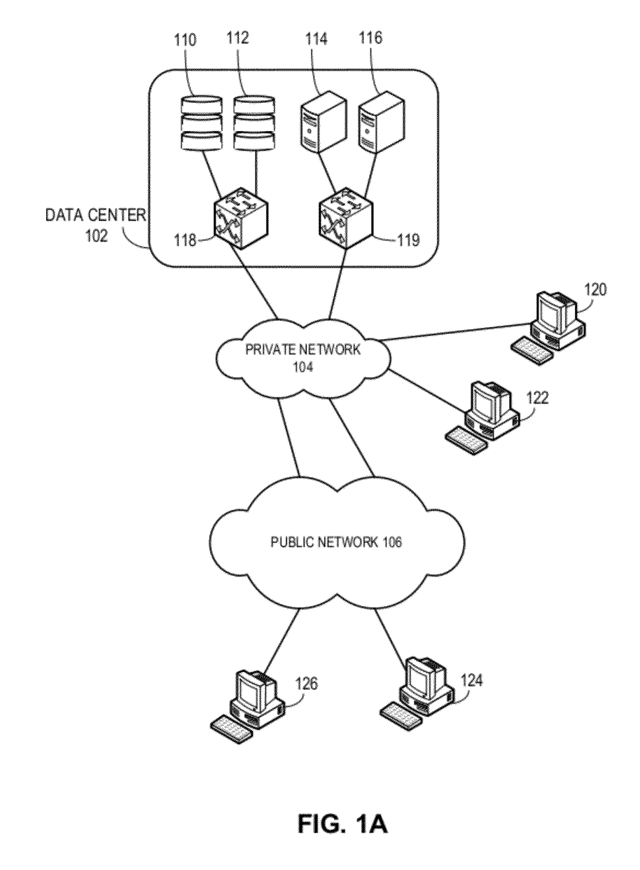

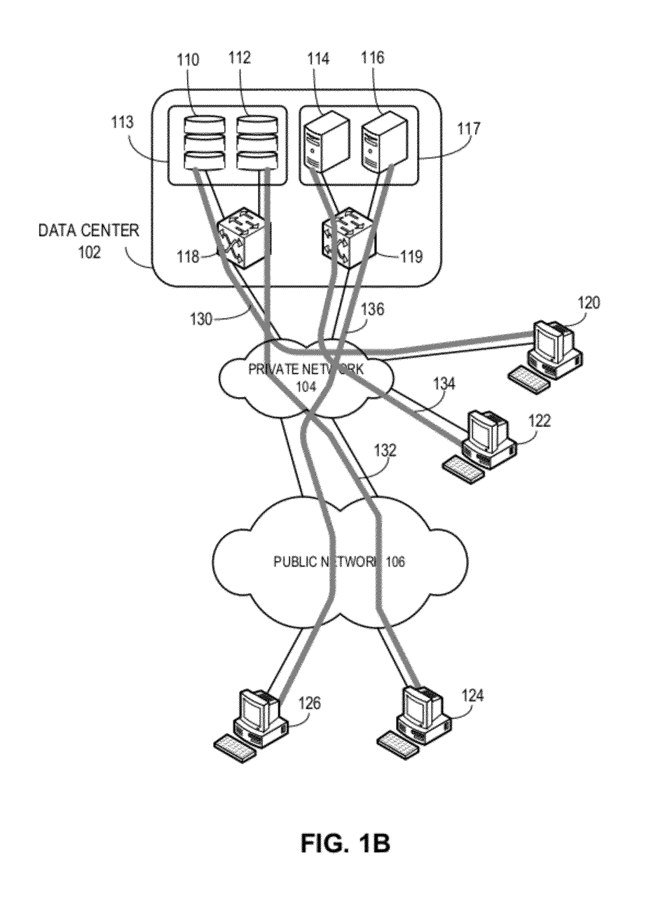

FIG. 1A illustrates an exemplary network environment that provides storage virtualization. In this example, a data center 102 includes two virtual storage devices 110 and 112, and two virtual servers 114 and 116. Virtual storage devices 110 and 112 are coupled to a gateway router 118, and virtual servers 114 and 116 are coupled to a gateway router 119. Gateway routers 118 and 119 are coupled to a private enterprise network 104, which is coupled to a public network 106. End hosts 120 and 122 are coupled to private network 104, and end hosts 126 and 124 are coupled to public network 106.

Typically, a virtual storage or virtual server can by identified within the same layer-2 domain by its layer-2 address information (such as Ethernet MAC address and/or virtual local area network (VLAN) tag). For example, virtual server 114 can address (and hence initiate communication sessions with) any of virtual storages 110 and 112. However, when a packet from any of the virtual storages or virtual servers has to travel outside the same layer-2 network domain (which in this example is data center 102's Ethernet domain), the packet typically needs to be forwarded by a layer-3 device (for example, an IP router). The layer-3 device removes the packet's layer-2 header information in order to process its layer-3 header. When the packet is forwarded to a next-hope layer-3 device, a new layer-2 header is attached. Hence, all the VM identifying information in the packet's original layer-2 header is lost. A remote host residing outside data center 102 (such as host 122) cannot address any VM within data center 102 directly. Consequently, an entity outside the same layer-2 network domain would not be able to initiate a communication session with a particular VM in data center 102.

Embodiments of the present invention solve the above problem by encapsulating a packet's layer-2 header information with a tunneling protocol. As a result, the VM identifying information is preserved when a packet is processed by a layer-3 device. A VM is therefore visible to entities residing outside its layer-2 network domain, and can be directly addressed by a remote host. With this new approach, any remote host in the example of FIG. 1, such as host 126, can initiate a communication session with any VM within data center 102 across a private and/or public network.

In one embodiment, a tunnel is established between the physical network interface cards of the physical host on which a VM resides and the physical network interface cards of a remote host. The network interface cards maintain a tunnel-to-VM mapping database, which allows packets encapsulated in a particular tunnel to be sent to one or more corresponding VMs. A number of tunneling protocols can be used, such as Multiprotocol Label Switching (MPLS), Virtual Private LAN Service (VPLS), and GRE.

At present, it is possible to establish a tunnel between a VM and a remote host directly at the VM level. In other words, a VM's software application can maintain a tunnel with a remote machine, which allows the remote host to initiate communication sessions with the VM. However, this approach is very vendor-specific and has poor interoperability between different vendors' products.

In addition, a network interface card is conventionally used as a piece of transmission equipment for point-to-point communication. It typically does not implement switch-like or router-like functions such as tunneling and complex header processing. Therefore, it is non-obvious to facilitate tunneling functions and maintain tunnel-to-VM mapping information on a network interface card.

Although the present disclosure is presented using examples of MPLS, VPLS, and GRE, embodiments of the present invention are not limited to any particular tunneling protocol. Any open-standard or proprietary network protocols can be used in various embodiments of the present invention.

Embodiments of the present invention are also not limited to a particular layer-2 or layer-3 protocol. Here “layer-2” refers to the data link layer according to the Open System Interconnection (OSI) model. “Layer-3” refers to the network layer in the OSI model. “Layer-2” can be based on a number of data link protocols, such as Ethernet and Asynchronous Transfer Mode (ATM), or a non-OSI defined data-link-layer equivalent protocol, such as Fibre Channel (FC). “Layer-3” can be based on any network layer protocols, such as IP. A “layer-2 network domain” refers to a part of a network where layer-2 header of a packet is preserved. Examples of a layer-2 network domain can be an Ethernet network where multiple segments are coupled by one or more switches. Forwarding of a packet within a layer-2 network domain does not involve any layer-3 processing; therefore, VM-identifying information in a packet is preserved in a layer-2 network domain.

The term “end host” refers to a computer that is typically not considered as a switch in a conventional sense. For example, an end host can be a client machine, a server, a storage device. An end host is usually a physical host. In certain context, an end host can also be a virtual machine.

The term “packet” refers to a group of bits that can be transported together across a network. “Packet” should not be interpreted as limiting embodiments of the present invention to layer-2 or layer-3 networks. “Packet” can be replaced by other terminologies referring to a group of bits, such as “frame,” “cell,” or “datagram.”

The terms “network interface,” “network interface card” and “network adapter” refer to a physical network interface, typically residing in an end host. A network interface can be an Ethernet network interface card (NIC), an FC host bus adapter (HBA), or a converged network adapter (CNA).

### Network Architecture

FIG. 1B illustrates using tunnels to achieve end-to-end virtualization, in accordance with an embodiment of the present invention. This example has a similar topology as the one in FIG. 1A. In this example, assume that virtual storage devices 110 and 112 reside in a physical machine 113, and virtual servers 114 and 116 reside on a physical machine 117. The network interface card on physical server 113 establishes two tunnels 130 and 132, with hosts 120 and 124, respectively. The network interface card on physical server 117 establishes tunnels 134 and 136, with hosts 122 and 126, respectively.

In one embodiment, the tunnels are established using MPLS between the network interface cards. A packet, together with its layer-2 headers, are encapsulated in the MPLS header and transported through private network 104 and/or public network 106. It is assumed that all the switches and/or routers along a packet's data path are capable of forwarding the packet based on its MPLS header. Hence, the payload inside the MPLS header, which includes VM identifying information carried in the layer-2 header, can be preserved. More details about the MPLS protocol can be found in Internet Engineering Task Force (IETF) RFCs 3037, 2547, 5036, 3209, and 4461, available at http://tools.ietf.org/html/, which are incorporated by reference herein.

Correspondingly, a remote host can learn a VM's layer-2 identifying information (for example, a combination of MAC address and VLAN tag) and directly address the VM. For example, host 124 can learn virtual storage 112's MAC address and VLAN tag, and use this combination to initiate communication with virtual storage device 112. The network interface card on host 124 can encapsulate the packets destined for virtual storage 112 with an MPLS label assigned to a tunnel corresponding to virtual storage 112.

To successfully address virtual storage 112, host 124's application may use an external IP address for virtual storage 112. This external IP address could be different from the actual, internal IP address assigned to virtual storage 112. In one embodiment, the network interface card on host 124 uses virtual storage 112's layer-3 address information (e.g., the external IP address, optionally combined with a layer-4 port number) and its layer-2 address information to identify virtual storage 112 and map it to tunnel 132.

In further embodiments, a remote host can identify a VM just by using its layer-2 address information. This configuration facilitates flexible migration of the VM, because when a VM moves to a different physical network, its layer-2 address typically does not change, whereas its IP address would often change. In this case, the remote host can still address the moved VM using its layer-2 address. When a VM moves to a different location, the routing of the corresponding tunnel needs to be updated accordingly. This update can be managed by a centralized entity using MPLS-like label-switched path (LSP) updates.

In one embodiment, when a tunnel is established, a tunnel-to-VM mapping relationship is established and distributed to the network interface cards on both ends of the tunnel. This operation, as well as the setting up of the tunnel through the network (label assignment and forwarding table updates along the LSP using the label distribution protocol (LDP)) can be performed by a centralized management station.

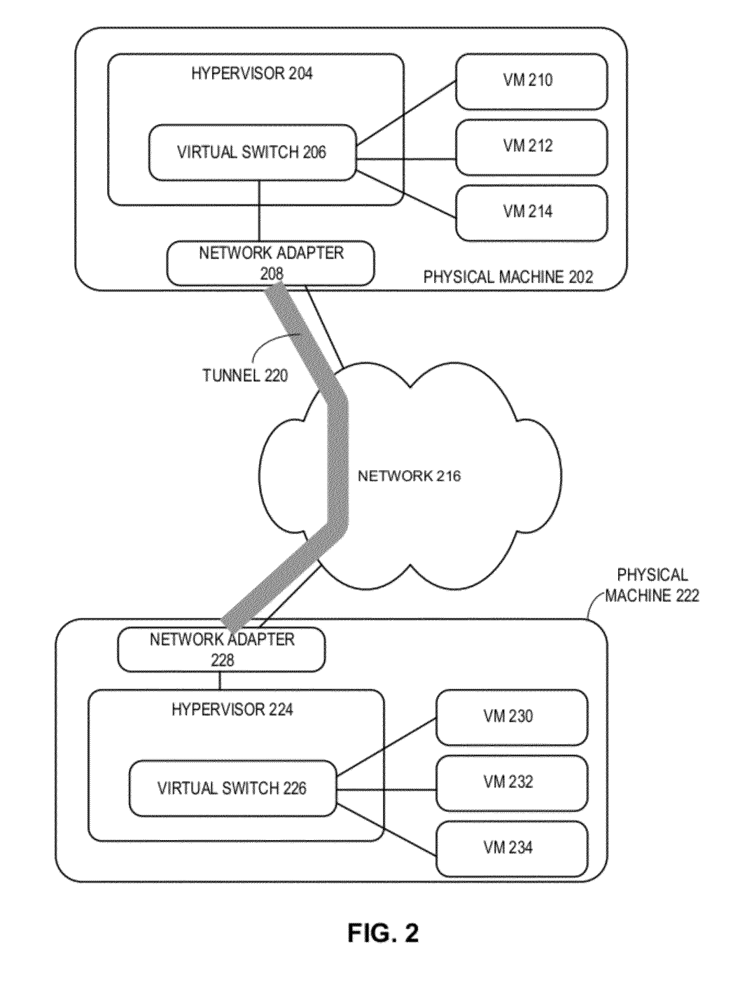

A more detailed illustration of using tunnels at network interface to facilitate end-to-end virtualization is illustrated in FIG. 2. In this example, a physical machine 202 is in communication with a physical machine 222 via a network 216. Physical machine 202 includes a network adapter 208 and a hypervisor 204. Hypervisor includes a virtual switch 206, which is coupled to VMs 210, 212, and 214. Similarly, physical machine 222 includes a network adapter 228 and a hypervisor 224. Hypervisor 224 includes a virtual switch 226 which is coupled to VMs 230, 232, and 234.

In one embodiment, an MPLS tunnel 220 is established between network adapter 208 and network adapter 228. Tunnel 220 is established for the communication between VM 232 and VM 214. In other words, the end points of a tunnel correspond to specific VMs (or physical host if one side of the tunnel is a physical machine instead of a VM). Either side of the tunnel can initiate communication. For example, VM 232 can generate a first packet with VM 214's MAC address (as its destination address (DA)) and VLAN tag. Virtual switch 226 then forwards this packet to network adapter 228. Network adapter 228 first inspects the destination MAC address in this packet. Based on the destination MAC address, network adapter 228 encapsulates the packet in an MPLS header corresponding to tunnel 220 and forwards the MPLS encapsulated packet to network 216.

Assume that network 216 has already been configured with an LSP corresponding to tunnel 220. When network adapter 208 receives this packet, it processes the packet's MPLS header and forwards it with VM 214's MAC address information to virtual switch 206. Virtual switch 206 in turn forwards the packet to VM 214.

In this example, a VM-specific tunnel is used. In other words, each tunnel is specific to a VM (or a pair of VMs when both ends of the tunnel are associated with VMs). The tunnel is logically bi-directional, and can be implemented as two uni-directional tunnels (for example, two MPLS LSPs running in opposite directions).

In further embodiments, a tunnel can be specific to a network adapter pair. That is, once a tunnel is established between two physical network interfaces, a number of VMs on either end can share this tunnel, if their packets are destined toward the same network interface on the other end. For example, tunnel 220 can be shared by VMs 210, 212, and 214 on one end, and be shared by VMs 230, 232, and 234 on the other end.

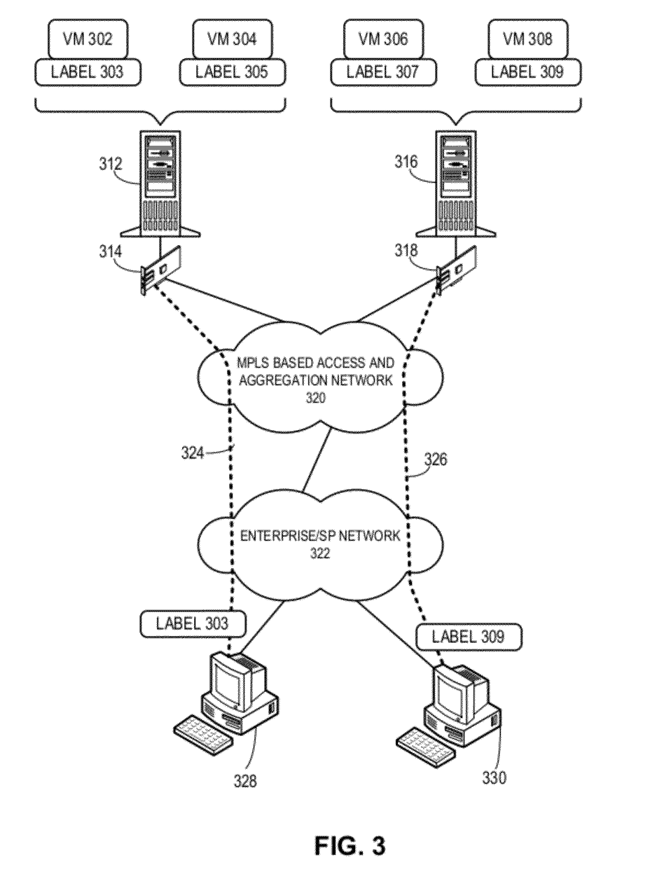

FIG. 3 illustrates how MPLS labels are used to establish tunnels to facilitate end-to-end virtualization, in accordance with one embodiment of the present invention. In this example, physical machines 312 and 316 are coupled to an MPLS based access and aggregation network 320. Physical machine 312 has a network adapter 314 and hosts VMs 302 and 304. Physical machine 316 has a network adapter 318 and hosts VMs 306 and 308.

MPLS based access and aggregation network 320 is coupled to an enterprise or service provider network 322, which is also coupled to physical hosts 328 and 330. During operation, two tunnels 324 and 326 are established. Tunnel 324 is established between the network adapters of host 328 and host 312, and facilitates the communication between host 328 and VM 302. Tunnel 324 is associated with an end-to-end LSP label 303. Typically, in MPLS networks, an MPLS label changes at every hop. In one embodiment, label stacking can be used, wherein an inner label is associated with the end-to-end data path.

Similarly, tunnel 326 is associated with label 309 and facilitates communication between host 330 and VM 308. VM 304 is associated with label 305, and VM 306 is associated with label 307. These two labels correspond to two other LSP tunnels, which are not shown in FIG. 3.

### Packet Format

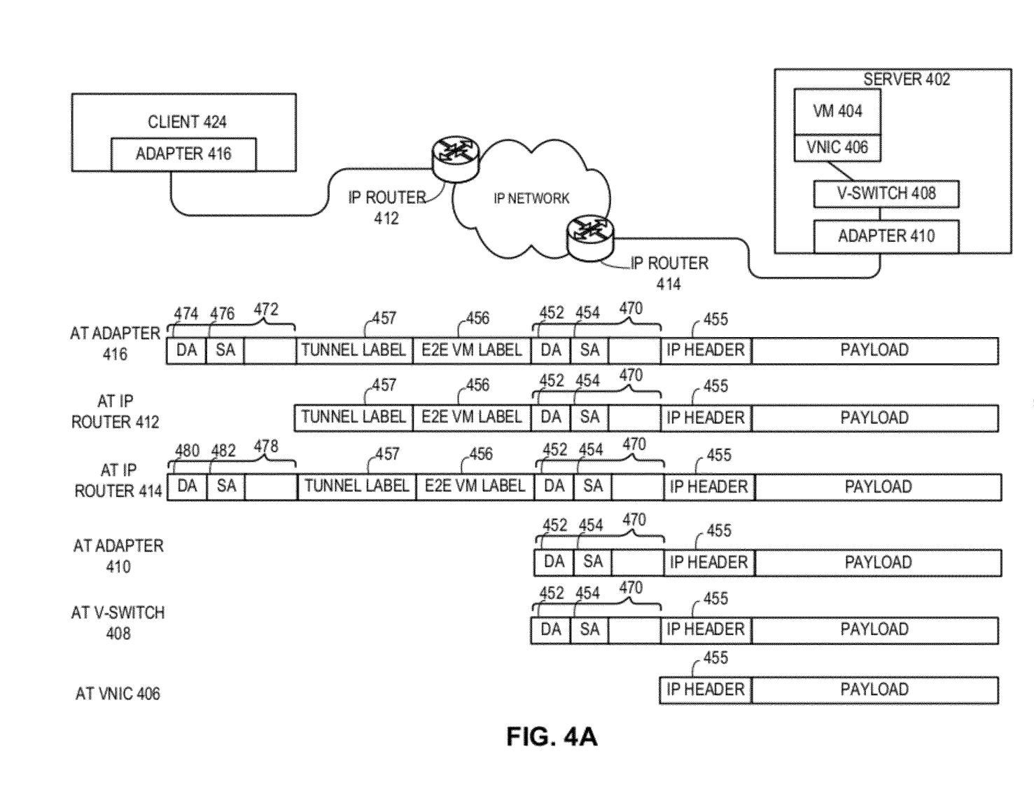

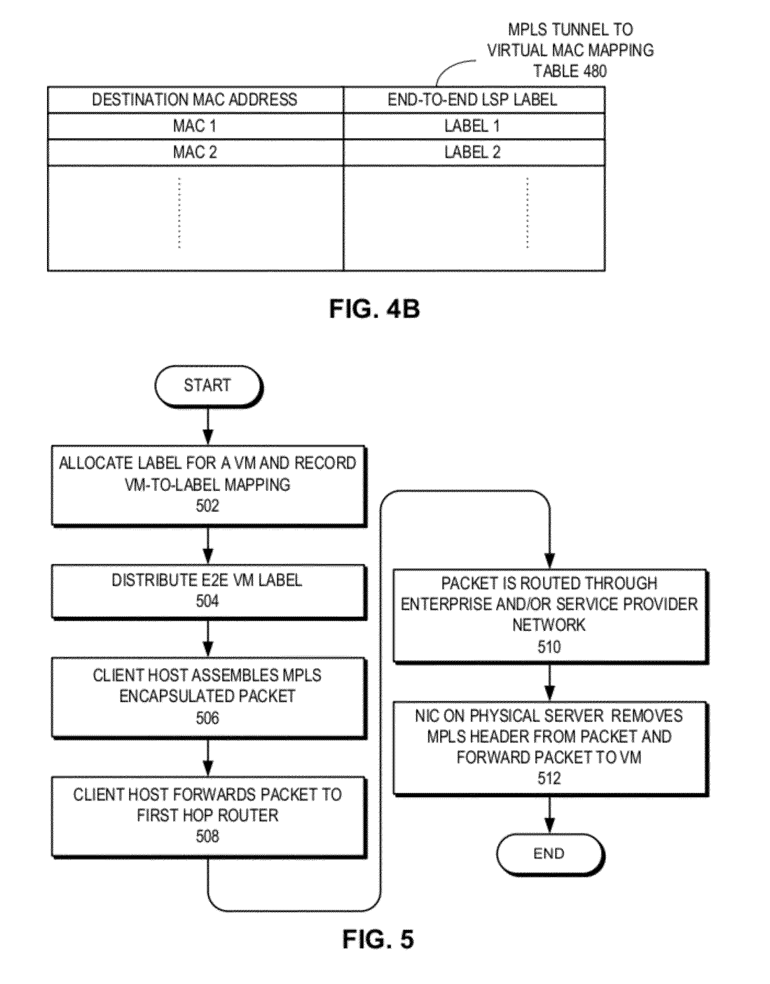

FIG. 4A presents a diagram illustrating how a packet can be encapsulated in tunneling protocol headers as it traverses a network that facilitates end-to-end virtualization, in accordance with an embodiment of the present invention. In this example, a physical client machine 424 is coupled to a gateway IP router 412 via network adapter 416. IP router 412 is coupled to a public IP network, which also includes IP router 414. IP router 414 is coupled to physical server 402, which includes a network adapter 410, a virtual switch 408, and a VM 404. VM 404 is coupled to virtual switch 408 via a virtual network interface card (VNIC) 406.

Before communication sessions can be initiated, a centralized management station (not shown) allocates an end-to-end label to designate the tunnel and the corresponding endpoints, which are VM 404 and client 424. The management station maintains tunnel-to-adapter and tunnel-to-VM/host mapping information, and distributes this mapping information to the end-point adapters of the tunnel.

In this example, adapter 416 maintains a mapping relationship between the tunnel and VM 404 (which can be identified by its MAC address and/or VLAN tag). Similarly, adapter 410 maintains a mapping relationship between the tunnel and client host 424.

Assume that client 424 initiates a communication session. At adapter 416, the outgoing packet includes a payload, an IP header 455, an Ethernet header 770 which includes a destination address (DA) 452 and source address (SA) 454, an inner MPLS label 456 (denoted as “E2E VM Label”), an outer MPLS label (457) (denoted as “Tunnel Label”), and an outer Ethernet header 472 which includes DA 474 and SA 476. IP header 455 is produced by the layer-3 software in client 424. Ethernet header 470 is considered the “inner” Ethernet header because it contains VM 404's MAC address in its DA field 452. Inner label 456 and outer label 457 are both part of the MPLS encapsulation header, which is added to the packet by adapter 416. Inner label 456 is used to indicate the end-to-end LSP tunnel. Outer label 457 is used by the MPLS-enabled switch or router along the LSP and is updated at each hop. Outer Ethernet header 472 is used for transmitting the packet from adapter 416 to IP router 412, assuming that the link between them is an Ethernet link. DA 474 in outer Ethernet header 472 indicates the next-hop device's (e.g., a gateway router's) MAC address on the receiving port. SA 476 indicates the adapter's own MAC address (as opposed to a VM's assigned MAC address in the case where the packet is generated by a VM).

At IP router 412, the outer Ethernet header 472 is removed and outer MPLS label (tunnel label) 457 is updated. The rest of the packet remains the same. Therefore, DA field 452, which identifies VM 404 and is part of inner Ethernet header 470, is preserved.

As the packet traverses the IP network, at router 414, the outer MPLS label 457 is updated again, and an outer Ethernet header 478 is added to the packet. Included in outer Ethernet header 478 is DA 480 and SA 482. DA 480 corresponds to adapter 410's MAC address, and SA 482 corresponds to router 414's MAC address.

Subsequently at adapter 410, the MPLS header is removed, and the packet is forwarded to virtual switch 408 with only the inner Ethernet header 470. Virtual switch 408 in turn forwards the packet to VNIC 406 with the original (inner) Ethernet header 470, which has VM 404's MAC address as its DA 452. VNIC 40 subsequently removes Ethernet header 470 and forwards the payload and IP header 455 to the upper protocol stack in VM 404.

Since an MPLS LSP tunnel is identified by the inner end-to-end label, a set of tunnel-to-VM mapping information is maintained at the end points (network interface cards) of the tunnel. FIG. 4B illustrates an exemplary MPLS tunnel-to-VM mapping table maintained at a network interface, in accordance with one embodiment of the present invention. In this example, an MPLS tunnel-to-VM mapping table 480 includes two columns. The left column contains the destination machine's MAC address, which identifies the target VM or physical host. Optionally, the left column can further specify the target machine's VLAN tag. The right column contains the end-to-end LSP label information, which indicates the tunnel corresponding to a specific VM.

### General Operation

FIG. 5 presents a flowchart illustrating the process of establishing tunnels to facilitate end-to-end tunneling, in accordance with an embodiment of the present invention. During operation, a centralized management station first allocates the end-to-end (E2E) label for a VM and records the VM-to-label mapping information (operation 502). The management station then distributes the E2E label to the network interface cards at both ends of the tunnel (operation 504). In addition, the corresponding LSP is set up within the network.

Next, a client host which initiates a communication session with the VM assembles an MPLS encapsulated packet (operation 506). In one embodiment, the network interface adapter on the client host looks up a VM-to-tunnel mapping table, and, based on the VM's layer-2 address, identifies the tunnel to use. The client host then forwards the packet at the first-hop router (operation 508). The packet is subsequently routed through an enterprise and/or service provider network (operation 510). When the packet reaches the physical server where the target VM resides, the network interface card on the physical server removes the MPLS header from the packet and forwards the packet to the target VM (operation 512).

Although the above examples are based on MPLS, embodiments of the present invention can also use other tunneling protocols to facilitate end-to-end virtualization. In one embodiment, GRE can be used to establish an end-to-end tunnel between two network interface cards. GRE packets are encapsulated within IP and use IP as a delivery protocol. Therefore, when GRE is used, an outer IP header is used outside the GRE header. Effectively, to preserve the layer-2 VM identifying information, the packet is encapsulated with layer-3 headers.

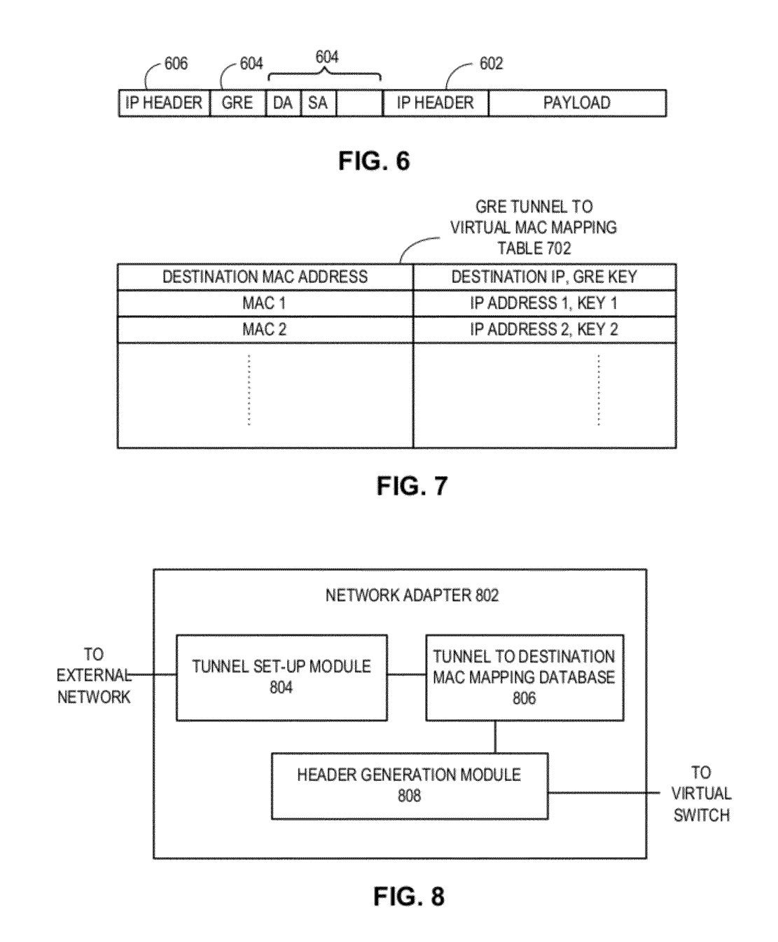

FIG. 6 illustrates an exemplary format of a GRE encapsulated packet transmitted by a network interface into the tunnel. This packet includes a payload and an IP header 602. Also included is an Ethernet header 604, whose DA corresponds to the target VM's MAC address. Up to this point, the content of the packet is similar to that of an MPLS encapsulated packet.

Outside Ethernet header 604 is a GRE header 604 and an outer IP header 606. The format of GRE header is specified in Internet Engineering Task Force (IETF) RFC 2890, available at http://tools.ietf.org/html/rfc2890, which is incorporated by reference herein. GRE header 604 is used in combination with outer IP header 606 to identify a header. The destination IP address and source IP address in IP header 606 specify the source and target network interfaces, respectively. In other words, assuming that the example in FIG. 4A is based on GRE, the source IP address in IP header 606 would be adapter 416's IP address, and the destination IP address in IP header 606 would be adapter 410's IP address.

It is possible that multiple GRE tunnels exist between two network interface cards. In one embodiment, the GRE key field in the GRE header can be used to distinguish different tunnels present between the same network interface pair (which is identified by their IP addresses). The GRE tunnel-to-VM mapping information is maintained at the network interface cards, similar to the configuration based on MPLS tunneling. FIG. 7 illustrates an exemplary GRE tunnel-to-VM mapping table maintained at a network interface, in accordance with one embodiment of the present invention. In this example, a GRE tunnel-to-VM mapping table 702 is stored at both network interface cards at both end points of a tunnel. GRE tunnel-to-VM mapping table 702 includes a left column which stores destination machine's MAC address (and optionally the destination machine's VLAN tag), and a right column which stores the destination machine's IP address and the GRE key corresponding to the tunnel. In this example, the combination of destination IP address and GRE key value can uniquely identify a GRE tunnel. Note that, it is possible that a tunnel starts at a the network interface of a machine that hosts a number of VMs, and terminates at a physical stand-alone host's network interface. In this case, the corresponding entry in table 702 would contain the physical stand-alone host's MAC address (instead of a VM's virtual MAC address) as the identifier of the end point.

### Network Interface Architecture

The features described above can be implemented in the hardware (e.g., ASICs) of a network interface card, or implemented in the software that drives the network interface card. For example, these functions can be implemented in a device driver for the network interface card, or implemented as part of the operating system, or implemented in the hypervisor. In addition, these functions can be implemented in a virtual switch residing on a network interface, wherein the virtual switch functions as an intermediary switching device between the VMs and the adapter.

FIG. 8 illustrates an exemplary network interface that supports end-to-end virtualization, in accordance with an embodiment of the present invention. In this example, a network adapter 802 includes a tunnel set-up module 804, a tunnel-to-destination MAC mapping database 806, and a header generation module 808. During operation, tunnel set-up module 804 receives instruction from a central tunnel management station about setting up a tunnel. In response, tunnel set-up module 804 sets up an LSP tunnel to the destination and makes a new entry in tunnel-to-destination MAC mapping database 806. Also coupled to the tunnel-to-destination MAC mapping database 806 is a header generation module 808. Header generation module 808 is responsible for generating the proper encapsulation header and other necessary layer-2 and/or layer-3 header before a packet is forwarded to the network. In one embodiment where MPLS is used as tunneling protocol, header generation module 808 is responsible for generating the MPLS header and the optional outer Ethernet header. In case of GRE, header generation module 808 is responsible for generating the GRE header, outer IP header, and optionally the outer Ethernet header. Header generation module 808 is coupled to the VM hosted on the machine. Tunnel set-up module 804 is coupled to the external network.

In summary, embodiments of the present invention provide a method and system for facilitating end-to-end virtualization. In one embodiment, a tunnel is set up from the network interface of one host to the network interface of a remote host. Packets to and from a VM are encapsulated by the tunneling protocol header, which preserves the VM identifying information.

The methods and processes described herein can be embodied as code and/or data, which can be stored in a computer-readable nontransitory storage medium. When a computer system reads and executes the code and/or data stored on the computer-readable nontransitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A network interface, comprising:
a tunnel set-up mechanism configured to set up a tunnel at the network interface which resides on an end host; and
an encapsulation mechanism configured to encapsulate a packet based on a tunneling protocol.

2. The network interface of claim 1, further comprising a data structure storing mapping information between a destination entity's identifying information and a tunnel's identifying information.

3. The network interface of claim 2, wherein the destination entity is a virtual machine.

4. The network interface of claim 2, wherein the destination entity's identifying information comprises at least one of a layer-2 address and a virtual local area network tag.

5. The network interface of claim 2, wherein the tunnel's identifying information comprises at least one of: a multiprotocol label switching (MPLS) label, an Internet Protocol (IP) address, and a generic routing encapsulation (GRE) key.

6. The network interface of claim 1, wherein the tunneling protocol is MPLS; and
wherein the encapsulation mechanism is configured to encapsulate the packet with an inner end-to-end label and an outer hop-by-hop label.

7. The network interface of claim 1, further comprising a decapsulation mechanism configured to decapsulate a packet encapsulated based on a tunneling protocol.

8. A method, comprising:
setting up a tunnel at a network interface residing on an end host; and
encapsulating at the network interface a packet based on a tunneling protocol.

9. The method of claim 8, further comprising storing mapping information between a destination entity's identifying information and a tunnel's identifying information.

10. The method of claim 9, wherein the destination entity is a virtual machine.

11. The method of claim 9, wherein the destination entity's identifying information comprises at least one of a layer-2 address and a virtual local area network tag.

12. The method of claim 9, wherein the tunnel's identifying information comprises at least one of: a multiprotocol label switching (MPLS) label, an Internet Protocol (IP) address, and a generic routing encapsulation (GRE) key.

13. The method of claim 8, wherein the tunneling protocol is MPLS; and
wherein the encapsulation mechanism is configured to encapsulate the packet with an inner end-to-end label and an outer hop-by-hop label.

14. The method of claim 8, further comprising decapsulating a packet encapsulated based on the tunneling protocol.

15. A computer readable storage medium storing instructions which when executed by a computer cause the computer to perform a method, the method comprising:
setting up a tunnel at a network interface residing on an end host; and
encapsulating at the network interface a packet based on a tunneling protocol.

16. The computer readable storage medium of claim 15, wherein the method further comprises storing mapping information between a destination entity's identifying information and a tunnel's identifying information.

17. The computer readable storage medium of claim 16, wherein the destination entity is a virtual machine.

18. The computer readable storage medium of claim 16, wherein the destination entity's identifying information comprises at least one of a layer-2 address and a virtual local area network tag.

19. The computer readable storage medium of claim 16, wherein the tunnel's identifying information comprises at least one of: a multiprotocol label switching (MPLS) label, an Internet Protocol (IP) address, and a generic routing encapsulation (GRE) key.

20. The computer readable storage medium of claim 15, wherein the tunneling protocol is MPLS; and
wherein the encapsulation mechanism is configured to encapsulate the packet with an inner end-to-end label and an outer hop-by-hop label.

21. The computer readable storage medium of claim 15, wherein the method further comprises decapsulating a packet encapsulated based on the tunneling protocol.
